(19) United States
(12) Patent Application Publication
(10) Pub. No.: US 2023/0237341 A1
(43) Pub. Date: Jul. 27, 2023

(54) SYSTEMS AND METHODS FOR WEAK SUPERVISION CLASSIFICATION WITH PROBABILISTIC GENERATIVE LATENT VARIABLE MODELS

(71) Applicant: JPMORGAN CHASE BANK, N.A., New York, NY (US)

(72) Inventors: Georgios PAPADOPOULOS, London (GB); Fanny SILAVONG, London (GB); Sean MORAN, London (GB); Rob OTTER, Witham (GB); Brett SANFORD, Tunbridge Wells (GB)

(21) Appl. No.: 18/156,882

(22) Filed: Jan. 19, 2023

(30) Foreign Application Priority Data
Jan. 26, 2022 (GR) 20220100071

(51) Int. Cl. G06N 3/0895; G06N 3/0475

(52) U.S. Cl. CPC G06N 3/0895; G06N 3/0475

(57) ABSTRACT

Systems and methods for weak supervision classification with probabilistic generative latent variable models are disclosed. A method for weak supervision classification with probabilistic generative latent variable models may include: (1) receiving, by a generative model computer program, a plurality of records from a database; (2) receiving, by the generative model computer program, a plurality of user-defined label functions; (3) labeling, by the generative model computer program, each of the plurality of records with each of the plurality of user-defined label functions; (4) representing, by the generative model computer program, the plurality of records that are labeled with the user-defined label functions in a matrix; (5) performing, by the generative model computer program, probabilistic latent variable model analysis on the matrix using a probabilistic generative latent variable model; and (6) outputting, by the generative model computer program, a labeled dataset for the plurality of records.

### RELATED APPLICATIONS

This application claims priority to, and the benefit of, Greek Patent Application No. 20220100071, filed Jan. 26, 2022, the disclosure of which is hereby incorporated, by reference, in its entirety.

### BACKGROUND OF THE INVENTION

### 1. Field of the Invention

Embodiments generally relate to systems and methods for weak supervision classification with probabilistic generative latent variable models.

### 2. Description of the Related Art

When training machine learning models on certain data, such as Big Data, there are challenges, such as labeled data is not available, external knowledge bases are unavailable for a specific use-case, model/application specifications are still in flux, etc. Therefore, manual labeling is required with the help of subject matter experts (SMEs).

### SUMMARY OF THE INVENTION

Systems and methods for weak supervision classification with probabilistic generative latent variable models are disclosed. According to an embodiment, a method for weak supervision classification with probabilistic generative latent variable models may include: (1) receiving, by a generative model computer program, a record from a database; (2) receiving, by the generative model computer program, user-defined patterns from subject matter experts; (3) receiving, by the generative model computer program, signals generated by other computer programs; (4) extracting, by the generative model computer program, information from the database based on the user-defined patterns and/or signals generated by the other computer programs; (5) representing, by the generative model computer program, the extracted information as a matrix; (6) performing, by the generative model computer program, probabilistic latent variable model analysis on the matrix using a probabilistic generative latent variable model; and (7) outputting, by the generative model computer program, a labeled dataset.

According to another embodiment, a method for weak supervision classification with probabilistic generative latent variable models may include: (1) receiving, by a generative model computer program, a plurality of records from a database; (2) receiving, by the generative model computer program, a plurality of user-defined label functions; (3) labeling, by the generative model computer program, each of the plurality of records with each of the plurality of user-defined label functions; (4) representing, by the generative model computer program, the plurality of records that are labeled with the user-defined label functions in a matrix; (5) performing, by the generative model computer program, probabilistic latent variable model analysis on the matrix using a probabilistic generative latent variable model; and (6) outputting, by the generative model computer program, a labeled dataset for the plurality of records.

In one embodiment, the record may be a code snippet, an email, or a news article.

In one embodiment, the probabilistic generative latent variable models may include Factor Analysis.

In one embodiment, the probabilistic generative latent variable models may include a Gaussian process latent variable model.

In one embodiment, the probabilistic generative latent variable models may include a Variational Inference Factor Analysis model.

In one embodiment, the method may also include labeling, by the generative model computer program, each of the plurality of records with a plurality of alternate label functions. The matrix may also include the plurality of records that are labeled with the alternate label functions.

In one embodiment, at least one of the alternate label functions may be based on coding standards.

In one embodiment, at least one of the user-defined label functions may be defined by a subject matter expert.

According to another embodiment, a non-transitory computer readable storage medium, may include instructions stored thereon, which when read and executed by one or more computer processors, cause the one or more computer processors to perform steps comprising: receiving a plurality of records from a database; receiving a plurality of user-defined label functions; labeling each of the plurality of records with each of the plurality of user-defined label functions; representing the plurality of records that are labeled with the user-defined label functions in a matrix; performing probabilistic latent variable model analysis on the matrix using a probabilistic generative latent variable model; and outputting a labeled dataset for the plurality of records.

In one embodiment, the record may be a code snippet, an email, or a news article.

In one embodiment, the probabilistic generative latent variable models may include Factor Analysis.

In one embodiment, the probabilistic generative latent variable models may include a Gaussian process latent variable model.

In one embodiment, the probabilistic generative latent variable models may include a Variational Inference Factor Analysis model.

In one embodiment, the non-transitory computer readable storage medium may also include instructions stored thereon, which when read and executed by one or more computer processors, cause the one or more computer processors to label each of the plurality of records with a plurality of alternate label functions. The matrix may also include the plurality of records that are labeled with the alternate label functions.

In one embodiment, at least one of the alternate label functions may be based on coding standards.

In one embodiment, at least one of the user-defined label functions may be defined by a subject matter expert.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for weak supervision classification with probabilistic generative latent variable models according to an embodiment;

FIG. 2 illustrates a method for weak supervision classification with probabilistic generative latent variable models according to an embodiment; and

FIG. 3 depicts an exemplary computing system for implementing aspects of the present disclosure.

### DETAILED DESCRIPTION OF PREFERRED EMBODIMENTS

Embodiments may build a data framework that allows the user and SMEs to generate pseudo-labels with the help of labelling functions (LFs). These LFs may be a set of heuristic rules that scan for specific keywords inside text, and categorize it accordingly. So, instead of SMEs spending time going through records item-by-item, they propose some rules that classify the data based on patterns. This is a family of weak supervision models.

A major challenge for these models is to map the dependencies amongst the LFs. To achieve this, embodiments use an approach that is based on the family of probabilistic generative latent variable models, and specifically on the Factor Analysis model (FA). The performance of the model remains high even when there is extremely sparse data and/or datasets that are characterized by class imbalance.

Embodiments improve upon existing work published in Ratner et al. “Data Programming: Creating Large Training Sets, Quickly” In Advances in Neural Information Processing Systems 29, 2016, 3567-3575 (available at arXIv:1605.07723); Ratner et al. “Snorkel metal: Weak supervision for multi-task learning.” In Proceedings of the Second Workshop on Data Management for End-To-End Machine Learning, DEEM '18, New York, N.Y., USA, 2018. (available at doi.org/10.1145/3209889.3209898), Ratner et al. “Snorkel: rapid training data creation with weak supervision.” In The VLDB Journal, 29(2-3):709-730, July 2019 (available at //doi.org/10.1007/s00778-019-00552-1); Ratner et al. “Training complex models with multi-task weak supervision.” In Proceedings of the AAAI Conference on Artificial Intelligence, 33:4763-4771, July 2019. (available at doi.org/10.1609/aaai.v33i01.33014763); Bach et al. “Learning the structure of generative models without labeled data.” In Proceedings of the 34th International Conference on Machine Learning—Volume 70, ICML '17, pp. 273-282. JMLR.org, 2017 (collectively, the “Incorporated Disclosures”). The disclosures of each of these references is incorporated, by reference, in its entirety. Embodiments use a more straightforward and interpretable approach to create approximate binary labels from noisy, unlabeled, datasets.

The incorporated disclosures uses an end-to-end machine learning pipeline that utilizes heuristically, user defined, binary labelling functions and a probabilistic matrix completion approach to generate pseudo-labels (approximate labels) for unlabeled datasets.

Embodiments use binary labelling functions use a robust probabilistic generative latent variable model (Factor Analysis). Then, embodiments dichotomize the latent output (Z) using the median value and we assign each variable (observation) to one of the two created groups.

For example, SMEs provide annotations heuristically where they may be translated programmatically to labelling functions. The unlabeled data is scanned with the labelling functions to create a sparse binary matrix. The sparse input matrix (labelling matrix) created by the labelling functions may be considered to contain all the information needed for a robust model creation. In other words, the labelling matrix can be interpreted as the sufficient statistics of the non-parametric machine learning model.

A probabilistic generative latent variable model, Factor Analysis (FA), may be used to map the correlations among the elements of the labelling matrix and then to generate a 1-dimensional latent factor (Z). Using the median, the latent variable Z is dichotomized, and each group of observations is assigned to a binary class. Alternatively, Gaussian Process Latent Variable Models (GPLVM) combined with Sparse Variational Gaussian processes (SVGP) may be used.

In one embodiment, heuristic labelling function techniques may be used to create a sparse labelling matrix. Next, the relationships among the labelling functions may be mapped using FA. Alternatively, any probabilistic generative latent variable model may be used, such as GPLVM.

Labelling functions may be user-defined programs that each provide a label for some subset of the data, and collectively generate a large but potentially overlapping set of training labels. Many different weak supervision approaches can be expressed as labeling functions, such as strategies which utilize existing knowledge bases. Rather than hand-labeling training data, SMEs can write labeling functions, which allow them to express various weak supervision sources such as patterns, heuristics, external knowledge bases, and more. In general, the true class label for a data point is modeled as a latent variable that generates the observed, noisy labels.

Latent variables may be the rule of local independence (e.g., the observed random variables of the model (X1, X2) are independent of each other given the existence of an unobserved variable Y), expected value of the observable phenomena (e.g., the expected value of the observable variable equals the latent true score Y=E(Xᵢ); and non-deterministic function of observed factors.

Embodiments may create a binary labelling matrix using the labeling functions. The Factor Analysis (FA) model may capture the dominant correlations among the data and subsequently finds a lower dimensional probabilistic description. FA may also be used for classification as it can model class conditional densities. Additional details may be found in the attached Appendix.

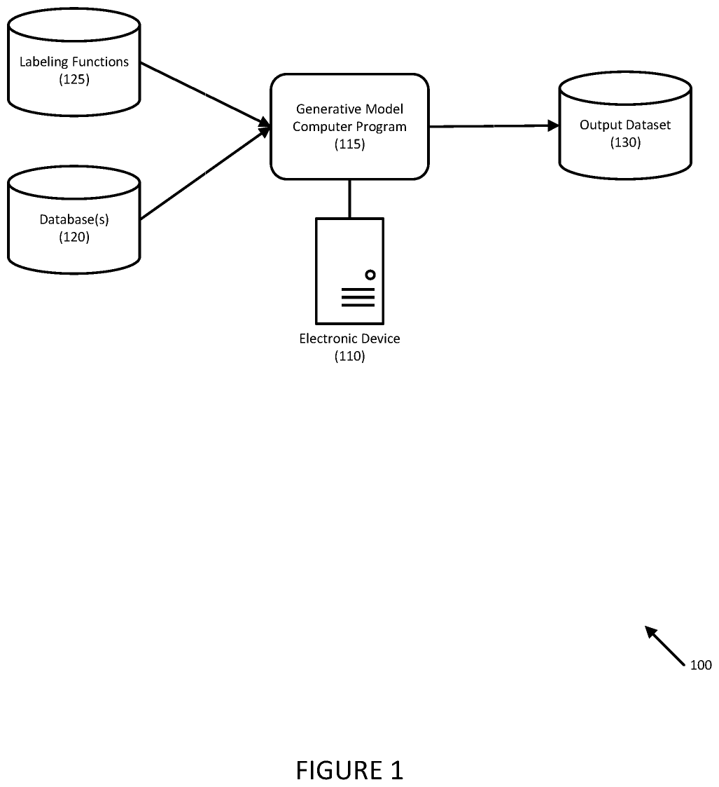

Referring to FIG. 1, a system for weak supervision classification with probabilistic generative latent variable models is disclosed according to an embodiment. System 100 may include electronic device 110, which may be a server (e.g., cloud and/or physical), computer, etc. that executes generative model computer program 115. Generative model computer program 115 may receive records, such as code snippets, emails, news articles, etc., from database 120 and labeling functions 125, which may be generated by SMEs.

SMEs may provide a general direction of what they consider a good or a bad record. For example, a SME may say that if a code snippet contains too many lines of code, it is not of good quality. That guidance may be translated into a label function that may be used to scan the code.

Generative model computer program 115 may generate a sparse label matrix, and may then apply probabilistic generative latent variable modelling, such as factor analysis. Generative model computer program 115 may then output a generated label dataset 130 to an output device, may store the generated label dataset in data repository 120, etc.

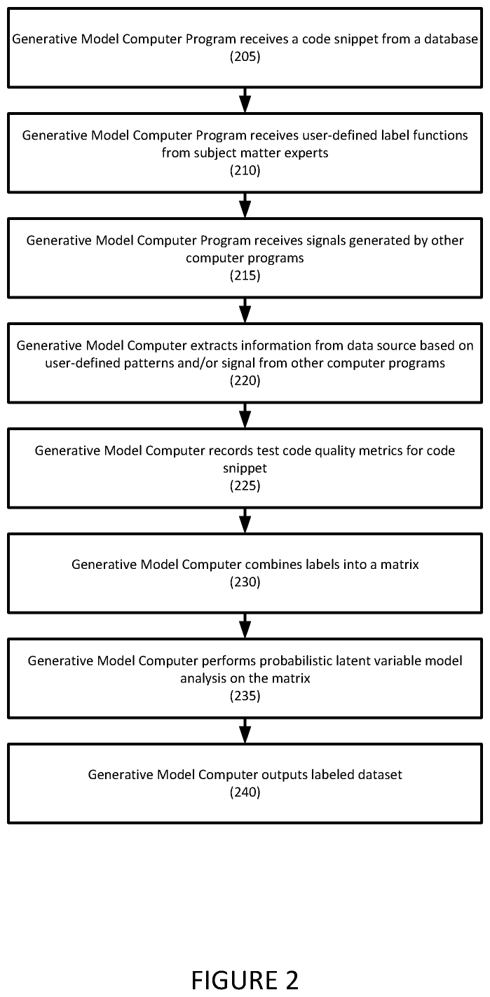

Referring to FIG. 2, a method for weak supervision classification with probabilistic generative latent variable models is disclosed according to an embodiment.

In step 205, a generative model computer program may receive a record (e.g., a code snippet, an email, a news article, etc.) from a database.

In step 210, the generative model computer program may receive user-defined label functions from subject matter experts. The label functions may heuristically scan the code snippet. For example, the output can be a non-labeled value (e.g., −1), a bad quality value (e.g., 0), or a good quality value (e.g., 1). Note that these values are exemplary only and other values may be used as is necessary and/or desired.

In step 215, the generative model computer program may receive signals generated by other computer programs. Any suitable signal may be received, and the signals may not be entirely user defined. Examples of signals may include signals that directly leverage historical behaviors from existing databases, signals that provide static code analysis, and signals that provide entity relationships generated by other machine learning models.

In step 220, the generative model computer program may extract information from the data source based on user-defined patterns and/or signals from other computer programs. For example, records in the data source may be scanned using the labelling functions and may be labeled (e.g., 0 for bad quality, 1 for good quality code, and −1 for a record that does not contain relevant information.

In one embodiment, a plurality of labeling functions may be applied to the records.

In optional step 225, the generative model computer program may record test quality metrics for the records. In one embodiment, the test quality metrics may be an alternative labelling function that checks the general quality of the records according to, for example, a coding standard. The generative model computer program may then label the records in the same manner used in step 220.

In step 230, the computer program may combine the labels from the user-defined function and the label from the alternate labeling function to populate a labelling matrix.

As an illustrative example, assume that there are 100 records, such as code snippets. In step 220, five labeling functions may be used, and in step 225, three quality labelling functions may be used. Thus, in step 230, the combined labelling matrix (−1, 0, 1) will have 100 rows and 8 columns that represent the combined labelling functions.

In step 235, the generative model computer program may perform probabilistic latent variable model analysis on the matrix using, for example, factor analysis. For example, using the sparse matrix A as an input to the Factor Analysis model:

$$p ( z \vert Λ ) = \frac{p ( Λ \vert z ) p ( z )}{p ( Λ )}$$

embodiments may optimize the model by maximizing its negative log likelihood:

$$L ( Λ \vert W , z , Ψ ) = - \frac{1}{2} {\sum }^{N} {( Λ - c )}^{T} {\sum }^{- 1} ( Λ - c ) - \frac{N}{2} log ( 2 π ) - \frac{1}{2} log det ( \sum )$$

Embodiments may then predict approximate labels to the true target values by dichotomizing p (latent variable).

μ=(I+W^{T}Ψ⁻¹W)⁻¹W^{T}Ψ⁻¹(Λ−c)

Σ=(I+W^{T}Ψ⁻¹W)⁻¹

In step 240, the generative model computer program may output a labeled dataset.

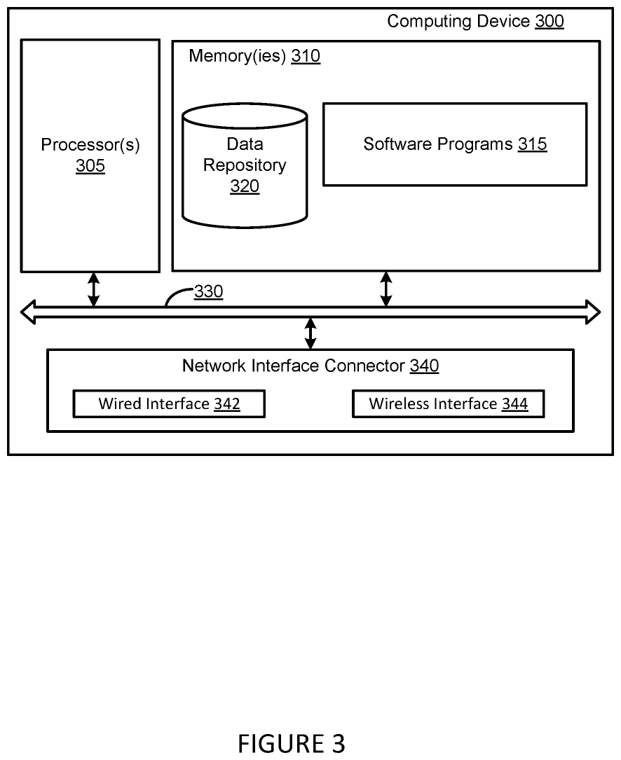

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for weak supervision classification with probabilistic generative latent variable models comprising:
receiving, by a generative model computer program, a plurality of records from a database;
receiving, by the generative model computer program, a plurality of user-defined label functions;
labeling, by the generative model computer program, each of the plurality of records with each of the plurality of user-defined label functions;
representing, by the generative model computer program, the plurality of records that are labeled with the user-defined label functions in a matrix;
performing, by the generative model computer program, probabilistic latent variable model analysis on the matrix using a probabilistic generative latent variable model; and
outputting, by the generative model computer program, a labeled dataset for the plurality of records.

2. The method of claim 1, wherein the record comprises a code snippet.

3. The method of claim 1, wherein the record comprises an email or a news article.

4. The method of claim 1, wherein the probabilistic generative latent variable models comprises Factor Analysis.

5. The method of claim 1, wherein the probabilistic generative latent variable models comprises a Gaussian process latent variable model.

6. The method of claim 1, wherein the probabilistic generative latent variable models comprises a Variational Inference Factor Analysis model.

7. The method of claim 1, further comprising:
labeling, by the generative model computer program, each of the plurality of records with a plurality of alternate label functions; and
wherein the matrix further comprises the plurality of records that are labeled with the alternate label functions.

8. The method of claim 7, wherein at least one of the alternate label functions is based on coding standards.

9. The method of claim 1, wherein at least one of the user-defined label functions is defined by subject matter expert.

10. A non-transitory computer readable storage medium, including instructions stored thereon, which when read and executed by one or more computer processors, cause the one or more computer processors to perform steps comprising:
receiving a plurality of records from a database;
receiving a plurality of user-defined label functions;
labeling each of the plurality of records with each of the plurality of user-defined label functions;
representing the plurality of records that are labeled with the user-defined label functions in a matrix;
performing probabilistic latent variable model analysis on the matrix using a probabilistic generative latent variable model; and
outputting a labeled dataset for the plurality of records.

11. The non-transitory computer readable storage medium of claim 10, wherein the record comprises a code snippet.

12. The non-transitory computer readable storage medium of claim 10, wherein the record comprises an email or a news article.

13. The non-transitory computer readable storage medium of claim 10, wherein the probabilistic generative latent variable models comprises Factor Analysis.

14. The non-transitory computer readable storage medium of claim 10, wherein the probabilistic generative latent variable models comprises a Gaussian process latent variable model.

15. The non-transitory computer readable storage medium of claim 10, wherein the probabilistic generative latent variable models comprises a Variational Inference Factor Analysis model.

16. The non-transitory computer readable storage of medium 10, further including instructions stored thereon, which when read and executed by one or more computer processors, cause the one or more computer processors to perform steps comprising:
labeling each of the plurality of records with a plurality of alternate label functions;
wherein the matrix further comprises the plurality of records that are labeled with the alternate label functions.

17. The non-transitory computer readable storage of medium 16, wherein at least one of the alternate label functions is based on coding standards.

18. The non-transitory computer readable storage of medium 10, wherein at least one of the user-defined label functions is defined by a subject matter expert.
